(19) United States
(12) Patent Application Publication
(10) Pub. No.: US 2026/0265538 A1
(43) Pub. Date: Sep. 10, 2026

(54) Aqueous Industrial Product Stabilized Against Microbial Contamination

(71) Applicant: Thor GmbH, Speyer (DE)

(72) Inventors: Thomas Wunder, Neustadt a.d. Weinstrasse (DE); Roman Grabbe, Neustadt a.d. Weinstrasse (DE)

(73) Assignee: Thor GmbH, Speyer (DE)

(21) Appl. No.: 19/159,296

(22) PCT Filed: Feb. 16, 2024
(86) PCT No.: PCT/EP2024/000011

§ 371 Date: Aug. 22, 2025

(30) Foreign Application Priority Data
Feb. 23, 2023 (EP) 23000028.3

(51) Int. Cl. C09D 5/14; C09D 7/63

(52) U.S. Cl. CPC C09D 5/14; C09D 7/63

(57) ABSTRACT

The invention relates to an aqueous industrial product selected from the group consisting of a paint, a plaster/render, a varnish, a stain, a polymer emulsion, a slurry and a pigment preparation, which contains (a) 0.03% to 1.4% by weight of guanidine and/or at least one salt of guanidine, the proportion by weight being based on the content of guanidine in the entire aqueous product, and which is characterized in that it has a pH in the range from pH 7.5 to 12.0. The invention further relates to a method for stabilizing an aqueous industrial product against microbial contamination, comprising the method steps of: (a) providing an aqueous industrial product, (b) mixing 0.03% to 1.4% by weight of at least one salt of guanidine with the aqueous industrial product, and (c) optionally adjusting the pH so that the stabilized aqueous industrial product has a pH in the range from pH 7.5 to 12.0. The present invention further relates to a method for producing an aqueous industrial product.

The invention relates to an aqueous industrial product selected from the group consisting of a paint, render, varnish, glaze, polymer emulsion, slurry and pigment preparation, comprising (a) 0.03% to 1.4% by weight of guanidine and/or at least one salt of guanidine, where the proportion by weight relates to the guanidine content in the overall aqueous product, and characterized in that the industrial product has a pH in the range from pH 7.5 to 12.0. The invention further relates to a method of stabilizing an aqueous industrial product against microbial infestation, comprising the following method steps: (a) providing an aqueous industrial product; (b) mixing 0.03% to 1.4% by weight of at least one salt of guanidine with the aqueous industrial product and (c) optionally adjusting the pH, such that the stabilized aqueous industrial product has a pH in the range from pH 7.5 to 12.0. The present invention further relates to a method of producing an aqueous industrial product.

Industrial products, in particular aqueous products, such as paints, varnishes, glazes, renders and emulsions, are typically produced using natural or biodegradable raw materials. These raw materials and the water used as solvent are frequently contaminated with microbes, such as bacteria, yeasts and fungi. If these products are produced without a preservative, they may already have high microbial counts one day after production.

In order to ensure that hygiene requirements are met by these products, and if appropriate also the constituents thereof used in production, and hence the shelf life of the industrial products is assured, what are called biocides are usually added to the products, or directly to the constituents thereof.

One class of biocides used for preservation of aqueous coating compositions, such as paints, plasters, varnishes or glazes, or constituents thereof, is called the 3-isothiazolin-3-ones. This substance class includes very antimicrobially active compounds with a different profile of action in some cases. It is often also the case that synergistic combinations of different 3-isothiazolin-3-ones are used in order to reduce the amount of biocides used. For example, WO 99/08530 A1 suggests the combined use of methylisothiazolin-3-one and 1,2-benzisothiazolin-3-one.

A further class of biocides is that of what are called the alkylguanidinium salts and also polyguanidinium salts. For example, it is known from the “Directory of microbicides for the protection of materials”, Springer 2005, pages 726 to 731, that an antimicrobial effect is possessed by medium- and long-chain guanidines and biguanidines, such as cocopropylenediamine-1,5-bisguanidinium acetates, bis(guanidinooctyl)amine triacetates, poly(hexamethylenebiguanidine) hydrochloride, di(4′-chlorophenyldiguanido)hexane, chlorhexidine digluconate, chlorhexidine diacetate.

Also known is use of such medium- and long-chain guanidine compounds together with other antimicrobial and/or fungicidal actives. A known example is the combination with 3-iodo-2-propynyl butylcarbamate, or formaldehyde depots. For example, EP 0 891 710 A1 teaches the combined use of dodecylguanidine hydrochloride and IPBC. However, the use of dodecylguanidine salts for preservation of paint compositions and polymer dispersions has been found to be problematic; for instance, incompatibilities in the form of coagulation were observable when these salts were added.

In some cases, the use of conventional biocides or preservatives is also not considered because they are increasingly subject to legal restrictions.

There have therefore already been suggestions to create storage-stable aqueous coating compositions of the type considered here without inclusion of conventional preservatives by increasing their pH to such a degree as to effectively prevent microbial infestation. The target pH here is at least 10, since microbial infestation cannot be prevented with sufficient certainty at lower pH values.

For instance, in the prior art, the pH is increased by adding waterglass, for example according to EP 1 297 079 A1.

Alternatively, DE10 2014 013 455 A1 and WO2017/144694A1 disclose the use of siliconates as pH-increasing additive.

However, a disadvantage of the above-described preservation methods is the comparatively high pH values in the coating compositions necessary for preservation, which entails particular care in handling thereof. Moreover, there have in recent times been increasing observations of infestation in these coating compositions by alkaliphilic germs, by microorganisms that can survive and multiply under alkaline conditions.

In spite of the numerous known combinations of active ingredients or measures taken in the meantime, increasing regulatory restrictions in particular are causing an increased demand for products stabilized against microbial infestation that preferably exclude or need only a reduced content of conventional preservatives or biocides, such as isothiazolinones, bronopol and pyrithiones.

This object is achieved by an aqueous industrial product stabilized against microbial infestation, selected from the group consisting of a paint, render, varnish, glaze, polymer emulsion, slurry and pigment preparation, comprising:
(a) 0.03% to 1.4% by weight, preferably 0.07% to 1.2% by weight, more preferably 0.1% to 1.0% by weight, of guanidine and/or at least one salt of guanidine, where the proportion by weight relates to the guanidine content in the overall aqueous product,
   characterized in that the industrial product has a pH in the range from pH 7.5 to 12.0, preferably from pH 8 to 11.5, more preferably from pH 8.5 to 11.

Because of their composition, the aqueous industrial products of the invention that have been stabilized against microbial infestation require a significantly lower level of and in some cases no preservatives as typically present in such products for in-can preservation. Nevertheless, because of the surprisingly effective interaction of the guanidine or guanidine salt and the corresponding pH in the range from pH 7.5 to 12.0, these products feature excellent resistance to microbial infestation, especially during storage. As a result, the above-identified industrial products are significantly improved in terms of environmental compatibility, and also have all known properties in terms of good and safe processing properties. Furthermore, the products of the invention are particularly protected against infestation by adapted alkaliphilic microorganisms, in particular against alkaliphilic bacteria and against neutrophilic to more weakly alkaliphilic bacteria. As a result, the formulation can be less alkaline, which is advantageous with regard to safe processing.

In a preferred embodiment of the invention, the aqueous industrial product is essentially free, preferably entirely free, of preservatives selected from the group consisting of 5-chloro-2-methyl-4-isothiazolin-3-one, 2-methyl-4-isothiazolin-3-one, 1,2-benzisothiazolin-3-one, N-butyl-1,2-benzisothiazolin-3-one, N-methyl-1,2-benzisothiazolin-3-one, octylisothiazolinone, dichloroctylisothiazolinone, dithiobisbenzmethylamide, formaldehyde and formaldehyde separators, quaternary ammonium compounds, bronopol, dibromnitrilopropionamide, dibromodicyanobutane, iodopropynyl butylcarbamate, thiabendazole, sodium pyrithione, zinc pyrithione, o-phenylphenol and combinations thereof.

What is meant by “essentially free” in this context is that the industrial product overall contains a total amount of less than 10 ppm, preferably less than 5 ppm, more preferably less than 1 ppm, based on the overall product.

For the purposes of the present invention, an aqueous industrial product generally means a water-containing industrial product selected from the group consisting of a paint, such as an interior paint, render, varnish, glaze, polymer emulsion, slurry and pigment preparation, including component (a) and having a pH within the claimed range.

The aqueous industrial product according to the present invention comprises the industrial products listed below:
coating compositions, such as paints, colors, plasters, varnishes and glazes,
polymer dispersions based on polyacrylate, polystyrene-acrylate, styrene-butadiene or polyvinylacetate,
pigment preparations, color pastes and tinting pastes and
slurries or pastes of raw materials, such as inorganic or organic color pigments, such as iron oxide pigments and carbon black pigments, or slurries or pastes of inorganic or synthetic fillers and pigments, such as kaolin, calcium carbonate, calcium silicate hydrate, calcium aluminate sulfate, titanium dioxide, gypsum, bentonite, magnesium silicates, smectite or talc.

More preferably, the aqueous industrial product of the invention is a paint, a render, varnish or glaze. The paint may be a paint for indoor use, or a paint for outdoor use. The render may likewise be a render for outdoor use, or else for indoor use. The render may likewise be a sealing compound or spackling compound for outdoor use, or else for indoor use.

In the context of the present invention, the unit “% by weight” relates in each case to the entire aqueous industrial product.

What is meant in the context of the invention by “at least one salt of guanidine” is that the aqueous industrial product contains one or two, three, four, five or six salts of guanidine, i.e. also includes a mixture thereof.

The aqueous industrial product of the invention contains, as component (a), guanidine and/or at least one salt of guanidine in an amount in the range from 0.03% to 1.4% by weight, where the stated proportion by weight relates to the content of guanidine in the entire industrial product, so as to accomplish stabilization against microbial infestation, especially during storage. The amount of component (a) required for stabilization in each case will be determined by the skilled person depending on the respective product with the aid of familiar methods. The aqueous industrial products stabilized against microbial infestation have improved stability to infestation by microorganisms compared to unstabilized aqueous industrial products, i.e. products which do not contain guanidine or a salt of guanidine or contain guanidine or a salt thereof in too small an amount, and therefore have a lower tendency to become microbially infested. In the context of the invention, it has been found that amounts of guanidine of up to 1.5% by weight, preferably up to 1.2% by weight, more preferably up to 1% by weight, are sufficient to ensure stabilization of the product against infestation by microorganisms. From a practical point of view, with regard to stabilization, and especially from an economic point of view, higher use amounts of guanidine than 1.4% by weight, for example, are undesirable.

The aqueous industrial product is characterized in that component (a) is present in the aqueous industrial product in the range from 0.03% to 1.4% by weight, preferably in the range from 0.07% to 1.2% by weight, more preferably in the range from 0.1% to 1.0% by weight, where the stated proportion by weight is based on the content of unsubstituted guanidine of the formula shown below:

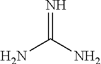

in the entire aqueous industrial product. Determination of the guanidine content is therefore based, in the presence of guanidine salts, solely on the content related to guanidine, not including any counterion.

The salt of guanidine that may be present in the aqueous industrial product is preferably at least one guanidine salt selected from the group consisting of guanidine hydrochloride, guanidine carbonate, guanidine nitrate, guanidine sulfate, guanidine thiocyanate, guanidine phosphate, guanidine hydrogencarbonate, guanidine formate, guanidine acetate, guanidine silicate and/or guanidine citrate. What is meant here by at least one guanidine salt is that one, two, three, four, five or even more guanidine salts may be present.

The salts of guanidine in the context of the present invention are unsubstituted guanidine or guanidinium salts of the general formula shown below:

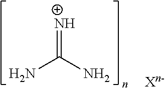

where n is 1, 2 or 3, and where the counterion Xⁿ⁻ is, for example, chloride, carbonate, nitrate, sulfate, thiocyanate, phosphate, hydrogencarbonate, formate, acetate or citrate.

In a preferred embodiment of the invention, the aqueous industrial product contains guanidine hydrochloride and/or guanidine carbonate as component (a), and in a particularly preferred embodiment of the invention the aqueous industrial product contains guanidine carbonate as component (a).

The pH of the aqueous industrial product is generally within a range from pH 7.5 to 12. In a preferred embodiment of the invention, the aqueous industrial product is characterized in that it has a pH in the range from 8 to 11.5, preferably a pH in the range from 8.5 to 11. Adjustment of the pH to a value in the range from 8.5 to 11 gives more skin-friendly industrial products, such as coating compositions, and hence products with additionally improved properties. In this way, the demands associated with the handling of the products of the invention in particular are lower.

The pH can be adjusted to the claimed range with the aid of measures familiar to the person skilled in the art.

This can be effected, for example, through the use of guanidine carbonate as the guanidine salt. The pH can likewise be adjusted to the claimed range by adding alkaline substances, also called alkalizers. Such compounds for adjusting the pH are known to the skilled person in the field; the respective amount of use may vary over wide ranges, which the skilled person will be able to ascertain with the help of methods familiar. Examples of alkalizers are:
guanidine carbonate,
alkali metal hydroxides such as lithium, sodium and/or potassium hydroxide,
alkaline earth metal hydroxides such as magnesium, calcium and/or barium hydroxide, ammonium hydroxide, xonotlite and/or ettringite (Ca₆[Al(OH)₆]₂(SO₄×26 H₂O)),
waterglass, such as sodium, lithium and potassium waterglass, or mixtures thereof,
siliconates, such as alkali metal alkylsiliconates or alkaline earth metal alkylsiliconates, in particular compounds of the general formula R—Si(OH)₂OM^{A} or [R—Si(OH)₂O]₂M^{E} in which M^{A} is an alkali metal, such as lithium, sodium, potassium, M^{E} is an alkaline earth metal, such as magnesium or calcium, and R is an alkyl radical, such as methyl, ethyl, n-propyl, i-propyl, n-butyl or i-butyl,
buffer systems, for example based on at least one phosphate or polyphosphate salt, preferably K₃PO₄ or Na₃PO₄, and at least one alkali metal hydroxide, preferably lithium, sodium and/or potassium hydroxide,
alkali metal and/or alkaline earth carbonates and/or hydrogencarbonates,
ammonia and ammonium compounds,
amines, amino compounds and amino alcohols.

In a preferred embodiment of the invention, the pH is adjusted to the claimed range with the aid of guanidine carbonate.

In the context of the present invention, what is meant by an aqueous industrial product is that the product has a water content that makes it susceptible to microbial infestation.

For the purposes of the present invention, an aqueous industrial product means a product selected from the group consisting of a paint, render, varnish, glaze, polymer emulsion, slurry and pigment preparation, in particular a water-based paint, varnish, glaze or render, having a water content of at least 10% by weight, preferably of at least 15% by weight, more preferably of at least 20% by weight. The paint may be a paint for indoor use, or a paint for outdoor use. The render may likewise be a render for outdoor use, or else for indoor use. It is likewise the case that the render in the context of the present invention may be a spackling compound for outdoor use, or else for indoor use. Such aqueous industrial products, as already outlined in the introduction, are typically produced using natural or biodegradable raw materials. These raw materials and the water used as solvent are frequently contaminated with microbes, such as bacteria, yeasts and fungi. The water content in the aqueous industrial product may vary over wide ranges and is preferably in the range from 10% to 90% by weight, based on the overall aqueous industrial product.

As already described in the introductory part of the description, there have already been suggestions to provide storage-stable aqueous coating compositions, such as paints and renders, of the type in question here with a low content, preferably a zero content, of conventional preservatives, by increasing the pH thereof so as to effectively prevent microbial infestation. The target pH here is at least 10. For instance, in the prior art, the pH is increased by adding waterglass, for example according to EP 1 297 079 A1. Alternatively, DE10 2014 013 455 A1 and WO2017/144694A1 disclose the use of siliconates as pH-increasing additive.

However, a disadvantage in these approaches to a solution is the necessary high pH values in the coating compositions, which entails special care in their handling. Moreover, there have in recent times been increasing observations of infestation in these coating compositions by alkaliphilic germs. There was therefore a need for products stabilized against microbial infestation, such as paints and renders, that need only a reduced content of conventional preservatives and preferably exclude conventional preservatives or biocides, such as isothiazolinones, pyrithiones and formaldehyde.

This further object is achieved by an aqueous industrial product stabilized against microbial infestation, selected from a paint and a render, comprising:
(a) 0.03% to 1.4% by weight, preferably 0.07% to 1.2% by weight, more preferably 0.1% to 1.0% by weight, of guanidine and/or at least one salt of guanidine, where the proportion by weight relates to the guanidine content in the overall aqueous industrial product,
(b) 1.0% to 85% by weight of pigment and/or filler,
(c) 1% to 30% by weight of polymer dispersion, calculated by solids content, and
(d) proportions of water to up to 100% by weight,
   characterized in that the industrial product has a pH in the range from pH 7.5 to 12.0, preferably in the range from pH 8.5 to pH 11.5, or has been adjusted to a pH in the range from pH 7.5 to 12.0, preferably in the range from pH 8.5 to pH 11.5.

It has been found that, surprisingly, in connection with this embodiment of the present invention, the presence of guanidine or its salt in the aqueous industrial product which is a paint or render, and which has a pH in the range from pH 7.5 to 12.0, preferably in the range from pH 8.5 to 11.5, affords a product which is significantly less susceptible to microbial infestation than those known from the prior art. The paints or renders of the invention in this embodiment, because of their composition, require a significantly lower level of preservatives, and in a preferred embodiment of the invention even no preservatives, in the form of what are called biocides, as typically present in coating compositions, such as emulsion paints and renders, for in-can preservation, and nevertheless have excellent storage stability. For outdoor use, however, additional biocidal substances, for example algicides and fungicides may be added to the paint or render as required for protection of the film.

In this preferred embodiment of the invention, the industrial product that is a paint or render is essentially free, preferably entirely free, of preservatives selected from the group consisting of 5-chloro-2-methyl-4-isothiazolin-3-one, 2-methyl-4-isothiazolin-3-one, 1,2-benzisothiazolin-3-one, N-butyl-1,2-benzisothiazolin-3-one, N-methyl-1,2-benzisothiazolin-3-one, octylisothiazolinone, dichloroctylisothiazolinone, dithiobisbenzmethylamide, formaldehyde and formaldehyde separators, quaternary ammonium compounds, bronopol, dibromnitrilopropionamide, dibromodicyanobutane, iodopropynyl butylcarbamate, thiabendazole, sodium pyrithione, zinc pyrithione, o-phenylphenol and combinations thereof.

What is meant by “essentially free” in this context is that the aqueous industrial product overall contains a total amount of less than 10 ppm, preferably less than 5 ppm, more preferably less than 1 ppm, based on the overall aqueous industrial product.

The salt of guanidine that may be present in the aqueous industrial product that is a paint or render is generally at least one guanidine salt selected from the group consisting of guanidine hydrochloride, guanidine carbonate, guanidine nitrate, guanidine sulfate, guanidine thiocyanate, guanidine phosphate, guanidine hydrogencarbonate, guanidine formate, guanidine acetate and/or guanidine citrate. What is meant here by at least one guanidine salt is that one, two, three, four, five or even more guanidine salts may be present.

In a preferred embodiment of the invention, the aqueous industrial product that is a paint or render contains guanidine hydrochloride and/or guanidine carbonate as component (a), and in a particularly preferred embodiment of the invention the aqueous industrial product contains guanidine carbonate as component (a).

The pH of the aqueous industrial product in this embodiment is generally within a range from pH 7.5 to 12. In a preferred embodiment of the invention, the aqueous industrial product is characterized in that it has a pH in the range from pH 8.5 to 11.5. Adjustment of the pH to a value in the range from pH 8.5 to 11.5 affords more skin-friendly paints or renders, and hence products having additionally improved properties, which is particularly advantageous with regard to safe processing thereof.

The aqueous industrial product that is a paint or render contains, as component (b), generally 1.0% to 85% by weight of pigment and/or filler. In a preferred embodiment of the invention, the coating composition contains 1% to 25% by weight of pigments and/or 5% to 50% by weight of fillers.

Pigments used may be the customary pigment admixtures to emulsion paints, such as titanium dioxide, iron oxide, chromium oxide, cobalt blue, phthalocyanine pigments, spinel pigments, and nickel and chromium titanates.

Fillers present in the composition are preferably silicates, carbonates, fluorspar, sulfates and oxides.

As component (c), the aqueous industrial product that is a paint or render generally contains 1% to 30% by weight, preferably 2% to 20% by weight, more preferably 3% to 12% by weight of polymer dispersion, calculated in each case as the solids content of the polymer dispersion. In the polymer dispersions present in the coating composition, it is possible to use any of the polymer dispersions known per se from the prior art in the field of coating or paint systems. The properties of the dispersion, but also of the finished products produced therefrom, are shaped predominantly by the respective polymer. This polymer is made up of various building blocks, called the monomers, which can also be combined with one another depending on the desired profile of properties. Suitable monomers are, for example, vinyl carboxylates having 3 to 20 carbon atoms, N-vinylpyrrolidone, vinylaromatics, vinyl halides, ethylenically unsaturated carboxylic acids, esters thereof, amides thereof or anhydrides thereof, nanohybrid dispersions, waterglass, silicone resin emulsions, aqueous polyurethane dispersions, styrene-acrylates, α-olefins and/or 1,3-dienes in the form of aqueous polymer dispersions or water-redispersible polymer powders. Particular preference is given to the use of ethylenically unsaturated carboxylic acids, in particular of acrylic and methacrylic acid, and also of ethylenically unsaturated carboxylic esters, in particular of acrylic and methacrylic esters having 1 to 12 carbon atoms in the alcohol radical. The alcohol radical of the esters may consist of linear or branched alkyl chains, cycloaliphatics or aromatics, which may additionally be modified with hydroxyl groups, halogen atoms or epoxy groups. Particular preference is also given to the use of styrene and styrene derivatives.

As component (d), the aqueous industrial product that is a paint or render contains proportions of water up to 100%. The water content may generally vary over wide ranges and is at least 10% by weight, preferably at least 15% by weight, more preferably at least 20% by weight.

Furthermore, the aqueous industrial product that is a paint or render may contain additional additives such as dispersants, thickeners, stabilizers, defoamers and/or hydrophobizing agents.

The invention also relates to the use of the aqueous industrial products of the invention that are paints or plasters for indoor and outdoor use. It has been found that these are particularly suitable for indoor use because of the absence of conventional in-can preservatives.

This invention further relates to a method of producing the aqueous industrial products of the invention, comprising the mixing of the components defined above.

The invention further relates to a method of stabilizing an aqueous industrial product, selected from the group consisting of a paint, render, varnish, glaze, polymer emulsion, slurry and pigment preparation against microbial infestation, which comprises the method steps of:
(a) providing an aqueous industrial product;
(b) mixing at least one salt of guanidine with the industrial product and
(c) optionally adjusting the pH,
   characterized in that the stabilized aqueous industrial product has a pH in the range from pH 7.5 to 12.0, preferably from pH 8 to 11.5, more preferably from pH 8.5 to 11, and further characterized in that the amount of the guanidine salt(s) is in the range from 0.03% to 1.4% by weight, preferably in the range from 0.07% to 1.2% by weight, more preferably in the range from 0.1% to 1.0% by weight, where the proportion by weight relates to the guanidine content in the overall aqueous industrial product.

It is advantageously a feature of the method of the invention that it can be used to produce aqueous industrial products which have been stabilized against microbial infestation and which, because of their composition, require a significantly lower level of preservatives, in some cases even no preservatives, as typically present in aqueous industrial products, such as emulsion paints, for in-can preservation. Nevertheless, because of the surprisingly effective interaction of the at least one guanidine salt or the guanidine resulting therefrom and the corresponding pH in the range from pH 7.5 to 12.0, these aqueous industrial products feature excellent resistance to microbial infestation, especially during storage. As a result, the products are distinctly improved in terms of their environmental compatibility.

In step (a) of the method of the invention, the aqueous industrial product to be stabilized against microbial infestation, selected from the group consisting of a paint, render, varnish, glaze, polymer emulsion, slurry and pigment preparation, is provided. What is meant by stabilizing against microbial infestation in the context of the present invention is that this, in the unstabilized state, especially during storage, has a tendency to become microbially infested and hence spoil.

The aqueous industrial product provided in step (a) is mixed in step (b) with at least one salt of guanidine. The amount of guanidine salt required for stabilization will be determined by the skilled person depending on the respective product with the aid of familiar methods. The aqueous industrial products stabilized against microbial infestation have improved stability to infestation by microorganisms compared to unstabilized aqueous industrial products, i.e. products which do not contain a salt of guanidine or guanidine, or contain the guanidine salt or guanidine in too small an amount, and therefore have a lower tendency to become microbially infested.

The amount of the guanidine salt(s) used in method step (b), depending on the industrial product provided, may vary over ranges and is in the range from 0.03% to 1.4% by weight, preferably in the range from 0.07% to 1.2% by weight, more preferably in the range from 0.1% to 1.0% by weight, where the percentage by weight is based on the guanidine content, not including any counterion, in the entire aqueous industrial product.

In a preferred embodiment of the invention, guanidine hydrochloride and/or guanidine carbonate is used in method step (b), and in a particularly preferred embodiment of the invention guanidine carbonate.

In method step (c) of the method of stabilizing the aqueous industrial product, the pH is optionally adjusted such that the aqueous industrial product has a pH in the range from pH 7.5 to 12.0, preferably in the range from pH 8 to 11.5, more preferably in the range from pH 8.5 to 11. What is meant here by “optionally” is that, as a result of the composition of the product, or else as a result of the guanidine salt used, after method step (b), the pH is already in the range from pH 7.5 to 12.0, preferably in the range from pH 8 to 11.5, more preferably in the range from pH 8.5 to 11, and so adjustment is unnecessary.

The invention further relates to a method of producing an aqueous industrial product stabilized against microbial infestation, selected from the group consisting of a paint, render, varnish, glaze, polymer emulsion, slurry and pigment preparation, which comprises the method steps of:
(a) providing an aqueous industrial product selected from the group consisting of a paint, render, varnish, glaze, polymer emulsion, slurry and pigment preparation,
(b) mixing at least one salt of guanidine with the aqueous industrial product such that the amount of the guanidine salt, based on the guanidine content in the overall aqueous industrial product, is in the range from 0.03% to 1.4% by weight, and
(c) optionally adjusting the pH,
   characterized in that the aqueous industrial product produced has a pH in the range from pH 7.5 to 12.0, preferably in the range from pH 8 to 11.5, more preferably in the range from pH 8.5 to 11.

It is advantageously a feature of the production method of the invention that it can be used to produce aqueous industrial products which have been stabilized against microbial infestation and which, because of their composition, require a significantly lower level of preservatives, in some cases even no preservatives, as typically present in these products, for in-can preservation. Nevertheless, because of the surprisingly effective interaction of the at least one guanidine salt and the corresponding pH in the range of pH 7.5 to 12.0, the industrial products feature excellent resistance to microbial infestation, especially during storage.

In step (a) of the production method of the invention, the aqueous industrial product to be stabilized against microbial infestation, selected from the group consisting of a paint, render, varnish, glaze, polymer emulsion, slurry and pigment preparation, is provided. What is meant by stabilizing against microbial infestation in the context of the present invention is that this, in the unstabilized state, especially during storage, has a tendency to become microbially infested and hence spoil.

The aqueous industrial product provided in step (a) is mixed in step (b) with at least one salt of guanidine. The amount of guanidine salt required for stabilization will be determined by the skilled person depending on the respective product provided with the aid of familiar methods. The products stabilized against microbial infestation have improved stability to infestation by microorganisms compared to unstabilized compositions, i.e. compositions which do not contain a salt of unsubstituted guanidine, or contain the guanidine salt in too small an amount, and therefore have a lower tendency to become microbially infested.

The amount of the guanidine salt(s) used in method step (b), depending on the product provided, may vary over wide ranges and is in the range from 0.03% to 1.4% by weight, preferably in the range from 0.07% to 1.2% by weight, more preferably in the range from 0.1% to 1.0% by weight, where the percentage by weight is based on the guanidine content, not including any counterions, in the entire aqueous industrial product.

In a preferred embodiment of the invention, guanidine hydrochloride and/or guanidine carbonate is used in method step (b), and in a particularly preferred embodiment of the invention guanidine carbonate.

In method step (c) of the method of producing the aqueous industrial product, the pH is optionally adjusted such that the product produced has a pH in the range from pH 7.5 to 12.0, preferably in the range from pH 8 to 11.5, more preferably in the range from pH 8.5 to 11. What is meant here by “optionally” is that, as a result of the composition of the product, or else as a result of the guanidine salt used, after method step (b), the pH is already in the range from pH 7.5 to 12.0, preferably in the range from pH 8 to 11.5, more preferably in the range from pH 8.5 to 11, and so adjustment is unnecessary.

The invention further relates to the use of guanidine and/or at least one salt of guanidine in an aqueous industrial product selected from the group consisting of a paint, render, varnish, glaze, polymer emulsion, slurry and pigment preparation having a pH in the range from pH 7.5 to 12.0, preferably in the range from pH 8 to 11.5, more preferably in the range from pH 8.5 to 11, in an amount in the range from 0.033% to 2.0% by weight, preferably in the range from 0.07% to 1.7% by weight, more preferably in the range from 0.1% to 1.4% by weight, where the proportion by weight relates to the guanidine content, not including any counterion, in the entire aqueous product, for stabilization of the aqueous product against microbial infestation. Advantageously, the inventive use of guanidine or at least one guanidine salt in the aqueous industrial product as defined above makes it possible to dispense with conventional preservatives as typically present in such products for in-can preservation. As a result, the products are distinctly improved in terms of their environmental compatibility. The claimed aqueous industrial products also have all known properties with regard to good and safe processing properties. Furthermore, the products of the invention are particularly protected against infestation by adapted alkaliphilic microorganisms and against neutrophilic to more weakly alkaliphilic microorganisms.

In a preferred embodiment, the present invention relates to an aqueous industrial product selected from the group consisting of a paint, render, varnish, glaze, polymer emulsion, slurry and pigment preparation, comprising:
(a) 0.03% to 1.4% by weight, preferably 0.07% to 1.2% by weight, more preferably 0.1% to 1.0% by weight, of guanidine and/or at least one salt of guanidine, where the proportion by weight relates to the guanidine content in the overall aqueous industrial product,
(b) 0.001% to 0.01% by weight, preferably 0.001% to 0.005% by weight, of 5-chloro-2-methylisothiazolin-3-one (CMIT) and
(c) proportions of water to up to 100% by weight,
   characterized in that the aqueous industrial product has a pH in the range from pH 9.0 to 11.0, or has been adjusted to a pH in the range from pH 9.0 to 11.

The advantages of this embodiment of the invention are that, firstly, 5-chloro-2-methylisothiazolin-3-one is present in the industrial product as what is called a quick-kill biocide, and results in rapid and effective killing of the germs present in the coating composition. In this way, for example, microorganisms such as bacteria, yeasts and fungi that are present from the production process are effectively and rapidly inactivated.

Furthermore, the alkaline pH of the aqueous industrial product leads to gradual degradation of the 5-chloro-2-methyl-4-isothiazolone, such that it is present only in comparatively low concentrations even after a few days, if at all, such that products can be considered to be largely unproblematic to the end user. Since the aqueous industrial product having a pH in the range from pH 9 to pH 11 further includes at least one guanidine salt, the product is additionally effectively stabilized against possible subsequent microbial postcontamination during transport and storage.

In a preferred embodiment of the invention, the aqueous industrial product is characterized in that the 5-chloro-2-methyl-4-isothiazolone (CMIT) has a 2-methyl-4-isothiazolin-3-one content in the range from 0% to 2% by weight, based on the total proportion of 5-chloro-2-methyl-4-isothiazolin-3-one.

This embodiment of the invention makes it possible in an advantageous manner to obtain products stabilized against microbial infestation using highly effective 5-chloro-2-methyl-4-isothiazolin-3-one, which, after production and storage are suitable in particular for individuals having a high degree of sensitization to 5-chloro-2-methylisothiazolin-3-one or 2-methylisothiazolin-3-one.

The following examples serve for the further illustration of the present invention:

In order to demonstrate stabilization of the claimed aqueous industrial products by the surprising interaction between the alkaline pH range and the guanidinium ions with respect to microbial infestation, various emulsion paints with different pH values and a calcium carbonate slurry as a constituent were admixed with different amounts of guanidine salts, and the stability thereof to microbial infestation was examined:

The paints tested and the constituents thereof were as follows:
Paint 1: emulsion paint (pigment volume concentration 77%) for indoor use with a pH of 7.8, produced in the laboratory based on vinyl acetate-ethylene binder, without addition of the otherwise customary conventional preservatives.
Paint 2: emulsion paint (pigment volume concentration 77%) for indoor use with a pH of 8.4, produced in the laboratory based on styrene-acrylate binder, without addition of the otherwise customary conventional preservatives.
Paint 3: commercially available, so-called preservative-free alkaline emulsion paint for indoor use with a pH of 11.3 (Alpinaweiss Das Original, free of solvents and preservatives)
Calcium carbonate slurry: calcium carbonate slurry, free of preservatives with a solids content of 78% and a pH of 9.2.

### Procedure:

Paints 1 to 3 were mixed and homogenized with various concentrations of the guanidinium salts to be tested.

The batches obtained of the paint thus prepared were inoculated repeatedly with a mixture of different wild-type bacterial strains that are of practical relevance with regard to contamination. These bacteria had previously been isolated from commercial emulsion paints containing conventional preservatives (bacteria mixture 1, Pseudomonas genus), which are microbially contaminated in practice, and commercial so-called preservative-free alkaline emulsion paints (bacteria mixture 2, alkaliphilic bacteria of the Nesterenkonia & Alkalibacterium genus), which are microbially contaminated in practice.

The calcium carbonate slurry was stored at 60° C. for 3 days prior to addition of the guanidinium salts for heat sterilization. The slurry thus treated was then admixed and homogenized with different concentrations of guanidine salts. The slurry prepared in this way was inoculated repeatedly with bacteria strains of practical relevance (bacteria mixture 3).

### Bacteria Mixture 1:

Pseudomonas spp. (Pseudomonas oleovorans group) DSM 33933
Pseudomonas aeruginosa DSM 33935
Pseudomonas oleovorans DSM 33936
Pseudomonas putida DSM 33937
Pseudomonas aeruginosa DSM 33938

### Bacteria Mixture 2:

Nesterenkonia sp. DSM 108520
Nesterenkonia sp. DSM 108521
Alkalibacterium pelagium DSM 108522
Nesterenkonia massiliensis DSM 110679
Nesterenkonia sp. DSM 108519

### Bacteria Mixture 3:

Alcaligenes faecalis NCIMB 13145
Aeromonas hydrophila DSM 6173
Escherichia coli DSM 13631
Burkholderia cepacia DSM 9241
Staphylococcus aureus DSM 799
Pseudomonas aeruginosa DSM 50071
Pseudomonas putida DSM 13624

The inoculum was added to the respective sample in each inoculation at 2% (v/w) as a fresh cell suspension in a physiological saline solution (0.9% NaCl). The cell count of the added inoculum in example 1 was 10⁵/ml, in examples 2 to 5 10⁹/ml, and in example 6 10⁶/ml, each in equal portions consisting of the individual bacterial strains. The cell suspension was produced by growing the individual bacteria at 30° C. for 24 h in liquid culture on a shaker. The medium used to grow the bacteria from bacteria mixture 1 was Müller-Hinton liquid medium. Bacteria from bacteria mixture 2 were grown in Müller-Hinton liquid medium that had been adjusted to pH 9.5-9.7 with an alkaline buffer solution beforehand. After growing, the individual liquid cultures were centrifuged, and the cells were resuspended in physiological saline solution. In order to adjust the mixture to the desired cell count, the individual bacteria suspensions, if necessary, were diluted accordingly before being combined with saline solution. The cell count of the inoculum was determined in each case by chamber counting.

In example 1, the samples were inoculated once with a bacteria suspension (bacteria mixture 1) with a cell count of 10⁵/ml (2% v/w) and the growth thereof was monitored by determining the live bacteria count per g of paint (colony-forming units, CFU/g) in the samples over 28 days. The CFU/g was determined each time by taking an aliquot (1 g) from the previously homogenized sample and running a serial decadic dilution series in physiological saline solution (0.9% NaCl) by streaking on tryptic soy agar, followed by incubation of the agar plates at 30° C. for 48 h.

In examples 2 to 6, what is called a repetitive stress test with bacteria was conducted by inoculating the samples at particular time intervals repeatedly with a bacteria suspension having a cell count of 10⁹/ml (2% v/w) and monitoring the evolution of the bacteria by a semiquantitative evaluation method. After each inoculation, the samples were incubated at 30° C. for 6 days (bacteria mixture 1 and 3) or 7 and 14 days (bacteria mixture 2), and after these periods bacterial infestation was evaluated semiquantitatively in each case. For this purpose, an aliquot was taken from each sample after homogenization using a sterile plastic inoculation loop (10 μl) and streaked evenly on agar plates (bacteria mixture 1 and 3 on tryptic soy agar, bacteria mixture 2 on DSMZ 31 alkaline nutrient agar). The streaked agar plates were then incubated at 30° C. for 48 h (bacteria mixture 1 and 3) or 5 to 7 days (bacteria mixture 2). After incubation, the bacterial colonies grown on the agar plates were visually evaluated and quantified according to the following scheme:

| Evaluation | Growth on the agar surface |
|---|---|
| 0 | No growth |
| 1 | Minimal growth, 1 to 10 colonies visible over the entire streak |
| 2 | Light growth, maximum 100 colonies |
| 3 | Moderate growth, maximum 300 to 400 colonies |
| 4 | Uniform growth, >400 colonies, single colonies still clearly |
| | recognizable |
| 5 | Heavy growth, too many colonies to count, but no growth |
| | over the entire streak |
| 6 | Full growth, barely any single colonies still apparent, |
| | growth over the entire streak |

A total of 3 inoculation cycles was performed in each repetitive stress test.

The results are shown in tables 1 to 6:

### EXAMPLE 1/TABLE 1

Inoculation 2% (w/v) with Bacteria Mixture 1, 10⁵ CFU/ml

| Concentration | | Colony forming units (CFU)/ | | | |
|---|---|---|---|---|---|
| % guanidine salt | | g of paint after days [d] | | | |
| (ppm guanidine) | pH | 0 d | 2 d | 5 d | 28 d |
| Paint 1 | | | | | |
| Blank | 7.8 | 1.3 × 10³ | 7.5 × 10³ | 2.1 × 10⁴ | 8.3 × 10⁶ |
| +0.01% guanidine | 8.1 | 1.2 × 10³ | 3.2 × 10³ | 3.0 × 10⁵ | 2.8 × 10⁶ |
| carbonate (67 ppm) | | | | | |
| +0.025% guanidine | 8.3 | 1.2 × 10³ | 1.1 × 10³ | 1.0 × 10⁵ | 2.3 × 10⁶ |
| carbonate (164 ppm) | | | | | |
| +0.05% guanidine | 8.5 | 9.0 × 10² | <5 | <5 | <5 |
| carbonate (328 ppm) | | | | | |
| +0.075% guanidine | 8.7 | 1.1 × 10³ | <5 | <5 | <5 |
| carbonate (492 ppm) | | | | | |
| +0.1% guanidine | 9.0 | 1.2 × 10³ | <5 | <5 | <5 |
| carbonate (656 ppm) | | | | | |

As can be inferred from the experimental results shown in table 1, even the addition of 0.05% by weight of guanidine carbonate to a paint having a pH of greater than or equal to pH 8.5 leads to distinct stabilization of the paint(s) against microbial infestation.

### EXAMPLE 2/TABLE 2

Inoculation 2% (w/v) with Bacteria Mixture 1, 10⁹ CFU/ml

| | | Bacterial growth | | |
|---|---|---|---|---|
| | | after inoculation | | |
| Concentration | | Incubation days [d] | | |
| % guanidine salt | | 1. | 2. | 3. |
| (ppm guanidine) | pH | 6 d | 6 d | 6 d |
| Paint 1 | | | | |
| Blank | 7.8 | 6 | 6 | 6 |
| Blank | 9.0 ¹⁾ | 6 | 6 | 6 |
| +0.25% guanidine hydrochloride | 7.7 | 6 | 6 | 6 |
| (1545 ppm) | | | | |
| +0.25% guanidine hydrochloride | 8.5 ¹⁾ | 3 | 6 | 6 |
| (1545 ppm) | | | | |
| +0.25% guanidine hydrochloride | 9.0 ¹⁾ | 0 | 4 | 6 |
| (1545 ppm) | | | | |
| +0.5% guanidine hydrochloride | 7.6 | 6 | 6 | 6 |
| (3090 ppm) | | | | |
| +0.5% guanidine hydrochloride | 8.5 ¹⁾ | 0 | 0 | 6 |
| (3090 ppm) | | | | |
| +0.5% guanidine hydrochloride | 9.0 ¹⁾ | 0 | 0 | 0 |
| (3090 ppm) | | | | |
| Paint 2 | | | | |
| Blank | 8.4 | 6 | 6 | 6 |
| Blank | 9.0 ¹⁾ | 6 | 6 | 6 |
| +0.25% guanidine hydrochloride | 7.8 | 6 | 6 | 6 |
| (1545 ppm) | | | | |
| +0.25% guanidine hydrochloride | 8.4 ¹⁾ | 6 | 6 | 6 |
| (1545 ppm) | | | | |
| +0.25% guanidine hydrochloride | 9.0 ¹⁾ | 0 | 0 | 6 |
| (1545 ppm) | | | | |
| +0.5% guanidine hydrochloride | 7.7 | 6 | 6 | 6 |
| (3090 ppm) | | | | |
| +0.5% guanidine hydrochloride | 8.4 ¹⁾ | 0 | 0 | 6 |
| (3090 ppm) | | | | |
| +0.5% guanidine hydrochloride | 9.0 ¹⁾ | 0 | 0 | 3 |
| (3090 ppm) | | | | |

¹⁾ pH adjusted with NaOH

As can be seen from the experimental results shown in table 2, even the addition of 0.25% by weight of guanidine hydrochloride to paint 1 having a pH of pH 8.5, or the addition of 0.25% by weight of guanidine hydrochloride to paint 2 having a pH of 9.0, leads to distinct stabilization of the paint(s) against microbial infestation.

### EXAMPLE 3/TABLE 3

2% (w/v) Inoculation with Bacteria Mixture 1, 10 CFU/ml

| | |
|---|---|
| | Bacterial growth |
| | after inoculation |
| Concentration | Incubation days [d] |

| % guanidine salt | | 1. | 2. | 3. |
|---|---|---|---|---|
| (ppm guanidine) | pH | 6 d | 6 d | 6 d |
| Paint 1 | | | | |
| Blank | 7.8 | | | |
| +0.5% guanidine hydrochloride | 7.6 | 6 | 6 | 6 |
| (3090 ppm) | | | | |
| +0.6% guanidine hydrochloride | 7.6 | 6 | 6 | 6 |
| (3708 ppm) | | | | |
| +0.7% guanidine hydrochloride | 7.5 | 5 | 6 | 6 |
| (4326 ppm) | | | | |
| +0.8% guanidine hydrochloride | 7.5 | 1 | 1 | 3 |
| (4944 ppm) | | | | |
| +0.9% guanidine hydrochloride | 7.5 | 0 | 0 | 0 |
| (5562 ppm) | | | | |
| +0.1% guanidine carbonate | 9.1 | 6 | 6 | 6 |
| (656 ppm) | | | | |
| +0.125% guanidine carbonate | 9.3 | 3 | 5 | 6 |
| (820 ppm) | | | | |
| +0.15% guanidine carbonate | 9.4 | 0 | 0 | 6 |
| (984 ppm) | | | | |
| +0.175% guanidine carbonate | 9.4 | 0 | 0 | 6 |
| (1148 ppm) | | | | |
| +0.2% guanidine carbonate | 9.6 | 0 | 0 | 0 |
| (1312 ppm) | | | | |
| +0.3% guanidine carbonate | 9.7 | 0 | 0 | 0 |
| (1968 ppm) | | | | |
| Paint 2 | | | | |
| Blank | 8.4 | 6 | 6 | 6 |
| +0.5% guanidine hydrochloride | 7.7 | 6 | 6 | 6 |
| (3090 ppm) | | | | |
| +0.6% guanidine hydrochloride | 7.7 | 4 | 6 | 6 |
| (3708 ppm) | | | | |
| +0.7% guanidine hydrochloride | 7.7 | 3 | 6 | 6 |
| (4326 ppm) | | | | |
| +0.8% guanidine hydrochloride | 7.6 | 0 | 0 | 0 |
| (4944 ppm) | | | | |
| +0.9% guanidine hydrochloride | 7.6 | 0 | 0 | 0 |
| (5562 ppm) | | | | |
| +0.1% guanidine carbonate | 8.9 | 6 | 6 | 6 |
| (656 ppm) | | | | |
| +0.125% guanidine carbonate | 9.0 | 6 | 6 | 6 |
| (820 ppm) | | | | |
| +0.15% guanidine carbonate | 9.0 | 6 | 6 | 6 |
| (984 ppm) | | | | |
| +0.175% guanidine carbonate | 9.1 | 0 | 0 | 6 |
| (1148 ppm) | | | | |
| +0.2% guanidine carbonate | 9.1 | 0 | 0 | 6 |
| (1312 ppm) | | | | |
| +0.25% guanidine carbonate | 9.1 | 0 | 0 | 6 |
| (1640 ppm) | | | | |
| +0.3% guanidine carbonate | 9.2 | 0 | 0 | 0 |
| (1968 ppm) | | | | |

The experimental results shown in table 3 clearly show that, in the case of paint 1, at a pH of 7.5, addition of 0.8% by weight of guanidine hydrochloride leads to distinct stabilization of the paint(s) against microbial infestation, and, at a pH of pH 9.4, addition of 0.15% by weight of guanidine carbonate. In the case of paint 2, at a pH of pH 7.6, addition of 0.8% by weight of guanidine hydrochloride led to distinct stabilization of the paint against microbial infestation, and, at a pH of pH 9.1, addition of 0.175% by weight of guanidine carbonate.

### EXAMPLE 4/TABLE 4

Inoculation 2% (w/v) with Bacteria Mixture 2, 10⁹ CFU/ml

| | | Bacterial growth | | |
|---|---|---|---|---|
| | | after inoculation | | |
| Concentration | | Incubation days [d] | | |
| % guanidine salt | | 1. | 2. | 3. |
| (ppm guanidine) | pH | 7 d/14 d | 7 d/14 d | 7d /14 d |
| Paint 1 | | | | |
| Blank | 7.8 | 0/0 | 5/6 | 6/6 |
| +0.1% guanidine carbonate | 9.1 | 0/0 | 0/0 | 6/6 |
| (656 ppm) | | | | |
| +0.15% guanidine carbonate | 9.4 | 0/0 | 0/0 | 0/0 |
| (984 ppm) | | | | |
| +0.2% guanidine carbonate | 9.6 | 0/0 | 0/0 | 0/0 |
| (1312 ppm) | | | | |
| +0.25% guanidine carbonate | 9.7 | 0/0 | 0/0 | 0/0 |
| (1640 ppm) | | | | |
| +0.3% guanidine carbonate | 9.7 | 0/0 | 0/0 | 0/0 |
| (1968 ppm) | | | | |
| +0.4% guanidine carbonate | 9.9 | 0/0 | 0/0 | 0/0 |
| (2624 ppm) | | | | |
| +0.5% guanidine carbonate | 10.1 | 0/0 | 0/0 | 0/0 |
| (3280 ppm) | | | | |
| +1.0% guanidine carbonate | 10.4 | 0/0 | 0/0 | 0/0 |
| (6560 ppm) | | | | |
| Paint 2 | | | | |
| Blank | 8.4 | 6/6 | 6/6 | 6/6 |
| +0.1% guanidine carbonate | 8.9 | 2/0 | 6/4 | 6/6 |
| (656 ppm) | | | | |
| +0.15% guanidine carbonate | 9.0 | 0/0 | 2/1 | 6/6 |
| (984 ppm) | | | | |
| +0.2% guanidine carbonate | 9.1 | 0/0 | 0/0 | 6/6 |
| (1312 ppm) | | | | |
| +0.25% guanidine carbonate | 9.1 | 0/0 | 0/0 | 0/0 |
| (1640 ppm) | | | | |
| +0.3% guanidine carbonate | 9.2 | 0/0 | 0/0 | 0/0 |
| (1968 ppm) | | | | |
| +0.4% guanidine carbonate | 9.3 | 0/0 | 0/0 | 0/0 |
| (2624 ppm) | | | | |
| +0.5% guanidine carbonate | 9.4 | 0/0 | 0/0 | 0/0 |
| (3280 ppm) | | | | |
| +1.0% guanidine carbonate | 9.8 | 0/0 | 0/0 | 0/0 |
| (6560 ppm) | | | | |

The experimental results shown in table 4 illustrate that even the addition of 0.1% by weight of guanidine carbonate to a paint 1 having a pH of 9.1 or greater or to paint 2 having a pH of 8.9 or greater leads to distinct stabilization of the paint(s) against microbial infestation.

### EXAMPLE 5/TABLE 5

Inoculation 2% (w/v) with Bacteria Mixture 2, 10⁹ CFU/ml

| | | Bacterial growth | | |
|---|---|---|---|---|
| | | after inoculation | | |
| Concentration | | Incubation days [d] | | |
| % guanidine salt | | 1. | 2. | 3. |
| (ppm guanidine) | pH | 7 d/14 d | 7 d/14 d | 7 d/14 d |
| Paint 3 | | | | |
| Blank | 11.3 | 6/6 | 6/6 | 6/6 |
| +0.1% guanidine carbonate | 11.2 | 3/0 | 3/0 | 5/0 |
| (656 ppm) | | | | |
| +0.15% guanidine carbonate | 11.2 | 3/0 | 3/0 | 4/0 |
| (984 ppm) | | | | |
| +0.2% guanidine carbonate | 11.2 | 3/0 | 3/0 | 3/0 |
| (1312 ppm) | | | | |
| +0.25% guanidine carbonate | 11.2 | 0/0 | 1/0 | 3/0 |
| (1640 ppm) | | | | |
| +0.3% guanidine carbonate | 11.2 | 0/0 | 1/0 | 3/0 |
| (1968 ppm) | | | | |
| +0.4% guanidine carbonate | 11.2 | 0/0 | 1/0 | 2/0 |
| (2624 ppm) | | | | |
| +0.5% guanidine carbonate | 11.2 | 0/0 | 0/0 | 1/0 |
| (3280 ppm) | | | | |
| +0.6% guanidine carbonate | 11.2 | 0/0 | 0/0 | 2/0 |
| (3936 ppm) | | | | |
| +0.7% guanidine carbonate | 11.2 | 0/0 | 0/0 | 0/0 |
| (4592 ppm) | | | | |
| +0.8% guanidine carbonate | 11.2 | 0/0 | 0/0 | 0/0 |
| (5248 ppm) | | | | |
| +1.0% guanidine carbonate | 11.2 | 0/0 | 0/0 | 0/0 |
| (6560 ppm) | | | | |

The experimental results shown in table 5 show that, in the case of paint having a pH of pH 11.2, addition of 0.1% by weight of guanidine carbonate already leads to distinct stabilization of the paint against microbial infestation.

### EXAMPLE 6/TABLE 6

Inoculation 2% (w/v) with Bacteria Mixture 3, 10⁶ CFU/ml

| | | Bacterial growth | | |
|---|---|---|---|---|
| | | after inoculation | | |
| | | Incubation days [d] | | |
| Concentration % guanidine | | 1. | 2. | 3. |
| salt (ppm guanidine) | pH | 6 d | 6 d | 6 d |
| Calcium carbonate slurry | | | | |
| Blank | 9.2 | 6 | 6 | 6 |
| +0.025% guanidine carbonate (164 ppm) | 9.3 | 6 | 6 | 6 |
| +0.05% guanidine carbonate (328 ppm) | 9.4 | 3 | 5 | 6 |
| +0.075% guanidine carbonate (492 ppm) | 9.4 | 0 | 3 | 6 |
| +0.1% guanidine carbonate (656 ppm) | 9.5 | 0 | 0 | 0 |

The experimental results shown in table 6 show that, in the case of a slurry having a pH of pH 9.4, addition of 0.075% by weight of guanidine carbonate already leads to distinct stabilization of the slurry against microbial infestation.

1. An aqueous industrial product selected from the group consisting of a paint, render, varnish, glaze, polymer emulsion, slurry and pigment preparation, comprising:
(a) 0.03% to 1.4% by weight of guanidine and/or at least one salt of guanidine, where the proportion by weight relates to the guanidine content in the overall aqueous product,
characterized in that the industrial product has a pH in the range from pH 7.5 to 12.0.

2. The industrial product as claimed in claim 1, characterized in that component (a) is present in the industrial product within a range from 0.07% to 1.2% by weight, where the proportion by weight relates to the guanidine content in the overall aqueous product.

3. The industrial product as claimed in claim 1, characterized in that the at least one guanidine salt is guanidine hydrochloride and/or guanidine carbonate.

4. The industrial product as claimed in claim 1, characterized in that component (a) is present within a range from 0.1% to 1.0% by weight, where the proportion by weight relates to the guanidine content in the overall aqueous product.

6. The industrial product as claimed in claim 1, characterized in that it has a water content in the range from 10% to 90% by weight.

7. The industrial product as claimed in claim 1, selected from a paint and a render, containing:
(a) 0.03% to 1.4% by weight of guanidine and/or at least one salt of guanidine, where the proportion by weight relates to the guanidine content in the overall aqueous industrial product,
(b) 1.0% to 85% by weight of pigment and/or filler,
(c) 1% to 30% by weight of polymer dispersion, calculated by solids content, and
(d) proportions of water to up to 100% by weight,
characterized in that the industrial product has a pH in the range from pH 7.5 to 12.0, or has been adjusted to a pH in the range from pH 7.5 to 12.

8. The industrial product as claimed in claim 1, containing:
(a) 0.03% to 1.4% by weight of guanidine and/or at least one salt of guanidine, where the proportion by weight relates to the guanidine content in the overall aqueous industrial product,
(b) 0.001% to 0.01% by weight of 5-chloro-2-methylisothiazolin-3-one (CMIT) and
(c) proportions of water to up to 100% by weight,
characterized in that the industrial product has a pH in the range from pH 9.0 to 11.0, or has been adjusted to a pH in the range from pH 9.0 to 11.

9. The industrial product as claimed in claim 8, characterized in that the 5-chloro-2-methyl-4-isothiazolone (CMIT) has a 2-methyl-4-isothiazolin-3-one content in the range from 0% to 2% by weight, based on the total proportion of 5-chloro-2-methyl-4-isothiazolin-3-one.

10. The industrial product as claimed in claim 1, characterized in that it contains one or more preservative(s) selected from the group consisting of 5-chloro-2-methyl-4-isothiazolin-3-one, 2-methyl-4-isothiazolin-3-one, 1,2-benzisothiazolin-3-one, N-butyl-1,2-benzisothiazolin-3-one, N-methyl-1,2-benzisothiazolin-3-one, octylisothiazolinone, dichloroctylisothiazolinone, dithiobisbenzmethylamide, formaldehyde and formaldehyde emitters, quaternary ammonium compounds, bronopol, dibromnitrilopropionamide, dibromdicyanobutane, iodopropynyl butylcarbamate, thiabendazole, sodium pyrithione, zinc pyrithione and o-phenylphenol in a total amount of less than 10 ppm, based on the product.

11. A method of stabilizing an aqueous industrial product selected from the group consisting of a paint, render, varnish, glaze, polymer emulsion, slurry and pigment preparation against microbial infestation, comprising the following method steps:
(a) providing an aqueous industrial product;
(b) mixing at least one salt of guanidine with the aqueous industrial product and
(c) optionally adjusting the pH,
characterized in that the stabilized aqueous industrial product has a pH in the range from pH 7.5 to 12.0, and further characterized in that the amount of the guanidine salt(s) is in the range from 0.03% to 1.4% by weight, where the proportion by weight relates to the guanidine content in the overall aqueous industrial product.

12. The method as claimed in claim 11, characterized in that the at least one guanidine salt is guanidine hydrochloride and/or guanidine carbonate.

13. A method of producing an aqueous industrial product, selected from the group consisting of a paint, render, varnish, glaze, polymer emulsion, slurry and pigment preparation, comprising the following method steps:
(a) providing an aqueous industrial product;
(b) mixing at least one salt of guanidine with the aqueous industrial product such that the amount of the guanidine salt, based on the guanidine content in the overall aqueous industrial product, is in the range from 0.03% to 1.4% by weight, and
(c) optionally adjusting the pH,
characterized in that the aqueous industrial product produced has a pH in the range from pH 7.5 to 12.0.
